(19) United States
(12) Patent Application Publication
(10) Pub. No.: US 2004/0189588 A1
(43) Pub. Date: Sep. 30, 2004

(54) [BACK LIGHT MODULE AND LIQUID CRYSTAL DISPLAY]

(76) Inventors: CHRIS DONG, MIAO-LI HSIEN (TW); CHE-CHIH CHANG, TAICHUNG (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/707,736

(22) Filed: Jan. 8, 2004

(30) Foreign Application Priority Data
Mar. 28, 2003 (TW) 92107064

(51) Int. Cl. G09G 3/36

(52) U.S. Cl. 345/102

(57) ABSTRACT

A back light module for providing a full-color surface light source. The back light module comprises a surface light source, a light-shielding matrix and a fluorescent layer. The light-shielding matrix is formed on the surface of the surface light source. The light-shielding layer has a plurality of lattice points that exposes the surface of the surface light source. The fluorescent layer is formed inside the lattice points. Through the fluorescent layer, light emitted from the surface light source is able to produce full coloration. A liquid crystal display comprises the back light module and a liquid crystal display panel. The liquid crystal display panel comprises an array substrate, an opposite substrate and a liquid crystal layer. The opposite substrate is positioned over the array substrate and the liquid crystal layer is sandwiched between the array substrate and the opposite substrate. The liquid crystal display panel is set up over the back light module.

### CROSS REFERENCE TO RELATED APPLICATIONS

This application claims the priority benefit of Taiwan application serial no. 92107064, filed on Mar. 28, 2003.

### BACKGROUND OF INVENTION

1. Field of Invention

The present invention relates to a back light module and a liquid crystal display. More particularly, the present invention relates to a back light module that provides a colorful surface light source and a liquid crystal display that uses such a back light module.

2. Description of Related Art

To match the life style of modern people, video or imaging equipment is becoming lighter and slimmer. Although the conventional cathode ray tube (CRT) has many advantages, the design of the electron gun renders it heavy and bulky. Moreover, there is always some danger of hurting viewer's eyes due to the production of a little radiation. With big leaps in the techniques in manufacturing semiconductor devices and opto-electronic devices, flat panel displays such as liquid crystal displays (LCD), organic light-emitting displays (OLED) and plasma display panels (PDP) have gradually become mainstream display products.

According to the light source, a liquid crystal display can be classified as belonging to one of three types: the reflective LCD, the transmissive LCD and the transflective LCD. Using a transmissive or a transflective LCD as an example, the LCD mainly comprises a liquid crystal panel and a back light module. The liquid crystal panel comprises a liquid crystal layer sandwiched between two transparent substrates. The back light module provides a surface light source to illuminate the liquid crystal panel for displaying some images. Note that both the reflective LCD and the transmissive LCD have a color-filtering film coated on the transparent substrate of the liquid crystal panel so that the liquid crystal display can have a full display of colors.

FIG. 1 is a schematic cross-sectional view of a conventional liquid crystal display. As shown in FIG. 1, the liquid crystal display 100 is a thin film transistor liquid crystal display (TFT-LCD) comprising a back light module 110 and a liquid crystal panel 120. The back light module 110 is positioned behind the liquid crystal panel 120 with reference to the user. The back light module 110 comprises a light-guiding plate 112, a linear light source 114 and a reflective holder 116. The light-guiding plate 112 is a wedge-shaped light-guiding plate having a light-incident surface 112a, a light-diffusing surface 112b and a light-emitting surface 112c. The reflective holder 116 is positioned next to the light-incident surface 112a and the linear light source 114 is enclosed within the reflective holder 116. The linear light source 114 is a lamp capable of producing a line of white light such as a cold cathode fluorescent lamp or a light-emitting diode array. Light from the light source 114 enters the light-guiding plate 112 through the light-incident surface 112a. After diffusion and reflection at the light-diffusing surface 112b, the light travels to the light-emitting surface 112c. In other words, the light-emitting surface 112c provides a white surface light source for illuminating the liquid crystal panel 120.

As shown in FIG. 1, the liquid crystal panel 120 comprises a thin film transistor (TFT) array substrate 130, a color-filtering substrate 140 and a liquid crystal layer 150. The liquid crystal layer 150 is sandwiched between the thin film transistor array substrate 130 and the color-filtering substrate 140. The thin film transistor array substrate 130 has a plurality of thin film transistors (TFT) 132 thereon and each thin film transistor 132 corresponds with a pixel electrode 134. Each thin film transistor 132 furthermore comprises a gate 132a, a channel layer 132b, a source 132c and a drain 132d. The gate 132a is connected to a scan line for turning on or turning off the channel layer 132b. The source 132c is connected to a data line. When the gate 132a is coupled to a suitable bias, the channel layer 132b is switched to a conductive state. In the conductive state, any data related to the display of an image will be written into the pixel electrode 134 through the data line, the source 132c, the channel layer 132b and the drain 132d. In short, the thin film transistor 132 serves as a switch for controlling the state of each pixel electrode 134 so that the desired image is displayed.

In addition, the color-filtering substrate 140 has a black matrix 142 thereon. The black matrix 142 exposes a plurality of lattice points on the surface of the color-filtering substrate 140. Each lattice point has a color-filtering film 144 thereon. The color-filtering film 144 within each lattice point can be a red color-filtering film, a green color-filtering film or a blue color-filtering film, for example. Furthermore, the color-filtering films 144 for filtering different colors can be distributed in various manners such as a mosaic, a triangular, a stripe or a four-pixel pattern within the lattice points of the black matrix 142.

The color-filtering substrate 140 also has a common electrode 146 thereon. Through the driving action of the thin film transistor 132, liquid crystal molecules inside the liquid crystal layer 150 between the common electrode 146 and the pixel electrode 134 are twisted. Furthermore, an alignment layer 148 over the common electrode layer 146 and an alignment layer 136 over the pixel electrode 134 are used to align the liquid crystal molecules inside the liquid crystal layer 150.

A plastic sealant 152 bounds the thin film transistor array substrate 130 and the color-filtering substrate 140 together. The cavity bounded by the thin film transistor array substrate 130, the color-filtering substrate 140 and the plastic sealant 152 holds the liquid crystal layer 150. In addition, a few spacers 154 may be introduced inside the cavity to maintain a constant cell gap between the thin film transistor array substrate 130 and the color-filtering substrate 140. Moreover, polarizing plates 160, 170 may be attached to the exterior surface of the thin film transistor array substrate 130 and the color-filtering substrate 140 respectively to display images.

Since the back light module 110 projects white surface light to the liquid crystal panel 120, light of various colors (for example, blue, red or green) must be produced through the color-filtering films 144 on the color-filtering substrate 140. In other words, full coloration in the liquid crystal display 100 mainly depends on the setup on the color-filtering substrate.

However, the color-filtering films on the color filtering substrate require more steps to fabricate and hence increase the overall cost of producing a liquid crystal display. Moreover, to prevent any non-planarity between the color-filtering films and the black matrix on the substrate, an over-coating is usually formed over the color-filtering films and the black matrix. The fabrication of this over-coating not only complicates the fabricating process of the color-filtering plate, but also increases the production cost.

### SUMMARY OF INVENTION

Accordingly, one object of the present invention is to provide a back light module capable of providing a full-colored surface light source so that a liquid crystal display using the back light module will become a full-colored liquid crystal display.

A second object of this invention is to provide a full-colored liquid crystal display without the need to fabricate any color-filtering films so that the process of fabricating a liquid crystal display is very much simplified and the cost of producing the display is reduced.

To achieve these and other advantages and in accordance with the purpose of the invention, as embodied and broadly described herein, the invention provides a back light module. The back light module comprises a surface light source, a light-shielding matrix and a fluorescent layer. The light-shielding matrix is formed on the surface of the surface light source. The light-shielding matrix has a plurality of lattice points that exposes the underlying surface light source. The fluorescent layer is formed within these lattice points.

This invention also provides a liquid crystal display. The liquid crystal display comprises a back light module and a liquid crystal display panel. The back light module furthermore comprises a surface light source, a light-shielding matrix and a fluorescent layer. The light-shielding matrix is formed on the surface of the surface light source. The light-shielding matrix has a plurality of lattice points that exposes the underlying surface light source. The fluorescent layer is formed within these lattice points. The liquid crystal display panel is positioned over the back light module.

According to one embodiment of the present invention, the surface light source of the back light module is produced from a system comprising a light-guiding plate, a reflective holder and a linear light source. The light-guiding plate has a light-receiving surface, a light-emitting surface and a light-diffusing surface. The light-diffusing surface has a plurality of V-cuts. The reflective holder is positioned next to the light-receiving surface and the linear light source is enclosed within the reflective holder. The linear light source is a cold cathode fluorescent lamp or a light-emitting diode array, for example. In addition, the surface light source of the back light module can be a cold cathode fluorescent flat lamp, for example.

According to another embodiment of the present invention, the fluorescent layer on the surface of the surface light source of the back light module comprises of a plurality of first fluorescent-based material, a plurality of second fluorescent-based material patches and a plurality of third fluorescent-based material. The first fluorescent-based material is capable of converting the light from the surface light source into a first color such as blue. The second fluorescent-based material is capable of converting the light from the surface light source into a second color such as red. The third fluorescent-based material is capable of converting the light from the surface light source into a third color such as green. Furthermore, the first fluorescent-based material, the second fluorescent-based material and the third fluorescent-based material can be arranged to form, for example, a mosaic, a triangular, a stripe or a four-pixel pattern.

In one embodiment of the present invention, the surface light source is capable of providing a first color such as blue. The fluorescent layer is positioned inside some of the lattice points of the light-shielding matrix. The fluorescent layer on the surface of the surface light source of the back light module comprises a plurality of first fluorescent-based material and a plurality of second fluorescent-based material. The first fluorescent-based material is capable of converting the light from the surface light source into a second color such as red. The second fluorescent-based material is capable of converting the light from the surface light source into a third color such as green. Furthermore, the first fluorescent-based material, the second fluorescent-based material and the lattice point without a fluorescent layer can be arranged to form, for example, a mosaic, a triangular, a stripe or a four-pixel pattern.

According to one embodiment of the present invention, the liquid crystal display panel comprises an array substrate, an opposite substrate and a liquid crystal layer. The opposite substrate is positioned over the array substrate. The liquid crystal layer is sandwiched between the opposite substrate and the array substrate. The array substrate is a thin film transistor array substrate, for example. The thin film transistor array substrate has a plurality of array thin film transistors on an interior surface and a plurality of pixel electrodes that correspond with the thin film transistors. The opposite substrate has a common electrode layer on an interior surface.

The interior surface of the thin film transistor array substrate additionally has a first alignment film that covers the thin film transistors and the pixel electrodes. Furthermore, the interior surface of the opposite substrate has a second alignment film that covers the common electrode layer. The first alignment film and the second alignment film are used for orienting the crystal molecules inside the liquid crystal layer.

In one embodiment of the present invention, the liquid crystal display panel comprises a bottom substrate, a top substrate and a liquid crystal layer. The top substrate is positioned over the bottom substrate. The liquid crystal layer is sandwiched between the top substrate and the bottom substrate. The bottom substrate has a plurality of first stripe electrodes and the top substrate has a plurality of second stripe electrodes. The first stripe electrodes extend in a direction perpendicular to the second stripe electrodes.

In addition, the interior surface of the bottom substrate has a first alignment film that covers the first stripe electrodes and the interior surface of the top substrate has a second alignment film that covers the second stripe electrodes. The first alignment film and the second alignment film are used for orienting the liquid crystals inside the liquid crystal layer.

According to the embodiment of the present invention, the liquid crystal display panel additionally includes a first polarizing plate and a second polarizing plate to display images. Furthermore, an optical film plate such as a prism plate is also inserted in the space between the liquid crystal display panel and the back light module.

In the present invention, a fluorescent layer is formed on the surface of a surface light source inside a back light module so that light of various colors are emitted from the surface light source. Moreover, after incorporating the full color back light module and the liquid crystal display panel together, there is no need to use a color-filtering film so that the process of fabricating a liquid crystal display panel is simplified and the overall cost of producing the display is lowered.

It is to be understood that both the foregoing general description and the following detailed description are exemplary, and are intended to provide further explanation of the invention as claimed.

### BRIEF DESCRIPTION OF DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a conventional liquid crystal display.

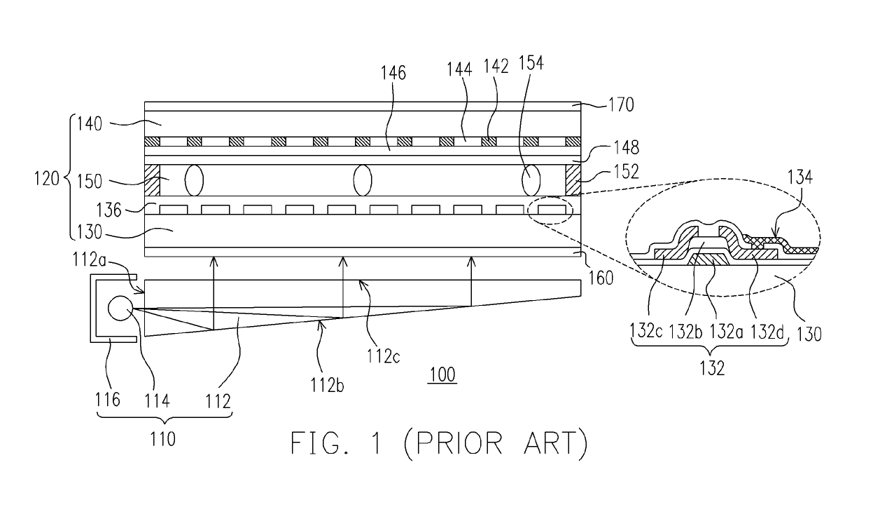

FIG. 2 is a schematic cross-sectional view of a back light module according to one preferred embodiment of the present invention.

FIGS. 3A to 3D are a series of pattern arrangement for a plurality of fluorescent-based material according to one preferred embodiment of the present invention.

FIG. 4 is a schematic cross-sectional view of a back light module according to another preferred embodiment of the present invention.

FIG. 5 is a schematic cross-sectional view of a liquid crystal display according to one preferred embodiment of the present invention.

### DETAILED DESCRIPTION

Reference will now be made in detail to the present preferred embodiments of the invention, examples of which are illustrated in the accompanying drawings. Wherever possible, the same reference numbers are used in the drawings and the description to refer to the same or like parts.

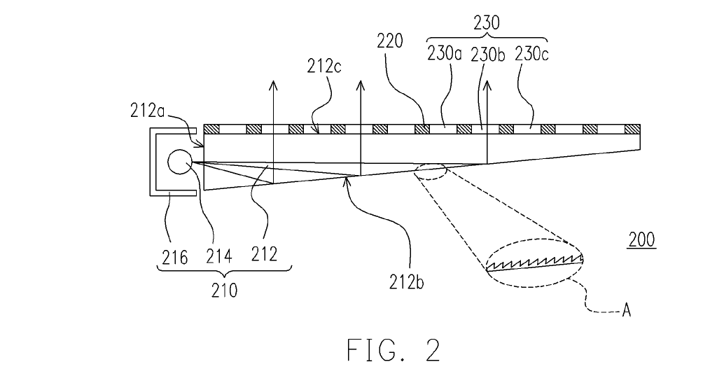

FIG. 2 is a schematic cross-sectional view of a back light module according to one preferred embodiment of the present invention. As shown in FIG. 2, the back light module 200 comprises a surface light source 210, a light-shielding matrix 220 and a fluorescent layer 230. The surface light source 210 furthermore comprises a light-guiding plate 212, a linear light source 214 and a reflective holder 216. The light-guiding plate 212 is a wedge-shaped light-guiding plate having a light-receiving surface 212a, a light-diffusing surface 212b and a light-emitting surface 212c. The light-diffusing surface 212b has a plurality of V-cuts (that can be seen in area A of FIG. 2). The reflective holder 216 is positioned next to the light-receiving surface 212a and the light source 214 is enclosed inside the reflective holder 216. The linear light source 214 is a lamp that provides a beam of white light such as a cold cathode fluorescent lamp (CCFL) or a light-emitting diode array. Light from the light source 214 enters the light-receiving surface 212a of the light-guiding plate 212. After diffusion and reflection by the light-diffusing surface 212b, the light emerges from the light-emitting surface 212c. In short, the light-emitting surface 212c provides a white surface light source for subsequent illumination.

The light-shielding matrix 220 is a black matrix positioned on the light-emitting surface 212c of the light-guiding plate 212, for example. The light-shielding matrix 220 has a plurality of lattice points that exposes the underlying light-emitting surface 212c. The fluorescent layer 230 is formed within these lattice points. In fact, the fluorescent layer 230 comprises of a plurality of first fluorescent-based material 230a, a plurality of second fluorescent-based material 230b and a plurality of third fluorescent-based material 230c. The first fluorescent-based material 230a is capable of converting the light from the surface light source 210 into a first color such as blue. The second fluorescent-based material 230b is capable of converting the light from the surface light source 210 into a second color such as red. The third fluorescent-based material 230c is capable of converting the light from the surface light source 210 into a third color such as green. In other words, through the three fluorescent-based materials, the surface light source 210 is able to emit three primary colors and equips the back light module 200 with the capacity to produce colors.

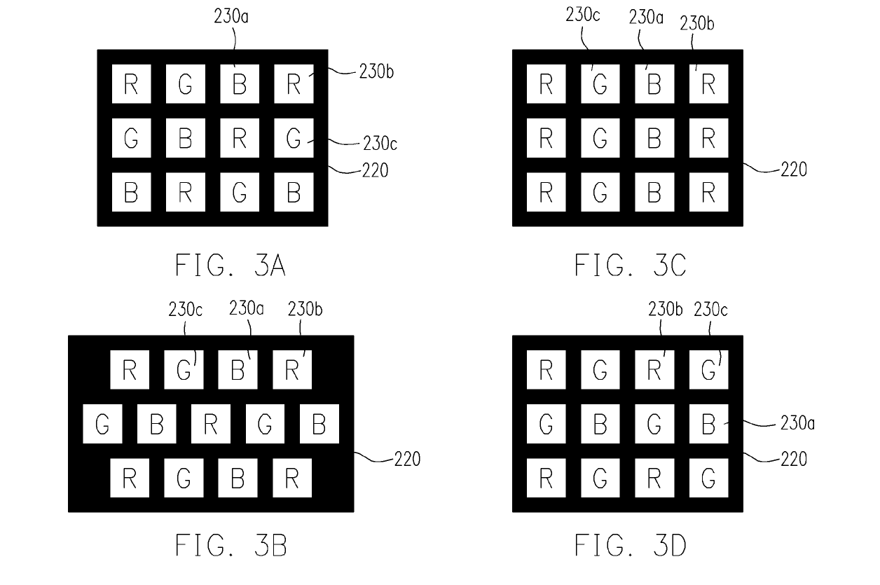

FIGS. 3A to 3D are a series of pattern arrangements for a plurality of fluorescent-based material according to one preferred embodiment of the present invention. As shown in FIGS. 3A to 3D, the first fluorescent-based material 230a, the second fluorescent-based material 230b and the third fluorescent-based material 230c can be arranged, for example, into a mosaic pattern (as shown in FIG. 3A), a triangular pattern (as shown in FIG. 3B), a stripe pattern (as shown in FIG. 3C) and a four-pixel pattern (as shown in FIG. 3D).

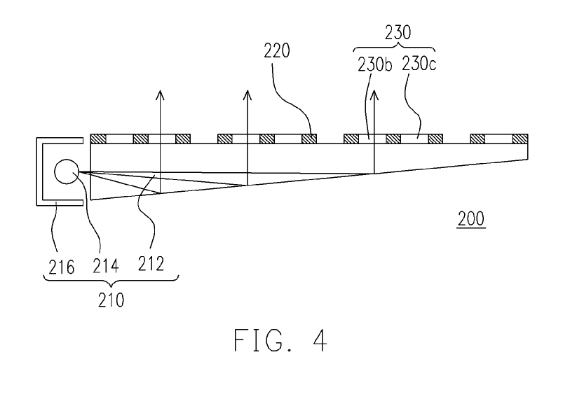

FIG. 4 is a schematic cross-sectional view of a back light module according to another preferred embodiment of the present invention. In the aforementioned embodiment, the back light module has the capacity to provide a full-color surface light source through the fabrication of a fluorescent layer containing different types of fluorescent-based materials. Hence, white light is converted into different colors. However, the surface light source is not limited to white light. For example, the linear light source 214 in FIG. 4 may produce light of a particular color such as blue. Hence, the surface light source 210 now emits blue light instead of white light. Note that the fluorescent layer 230 is formed within some of the lattice points of the light-shielding matrix 220 only. The fluorescent layer 230 comprises a plurality of first fluorescent-based material 230b and a plurality of second fluorescent-based material 230c. The fluorescent-based material 230b is capable of converting blue light into another color such as red. Similarly, the fluorescent-based material 230c is capable of converting blue light into yet another color such as green. For those lattice points without any fluorescent material, the blue light from the light source is able to penetrate through unhindered. Obviously, the first fluorescent-based material 230b, the second fluorescent-based material 230b and the lattice points not having any fluorescent material can be arranged to form, for example, a mosaic pattern, a triangular pattern, a stripe pattern or a four-pixel pattern. Since the surface light source is designed to emit a single color, one type of fluorescent-base material inside the lattice points is saved. Hence, the cost of producing the back light module is reduced.

In addition, the surface light source 210 as shown in FIGS. 2 and 4 is produced by matching the linear light source 214 with the light-guiding plate 212. However, anyone familiar with the technologies may directly use a cold cathode fluorescent flat lamp (CCFFL) instead. In this case, a fluorescent layer with different types of fluorescent-based material is formed on the surface of the CCFFL to produce a full panel of colors.

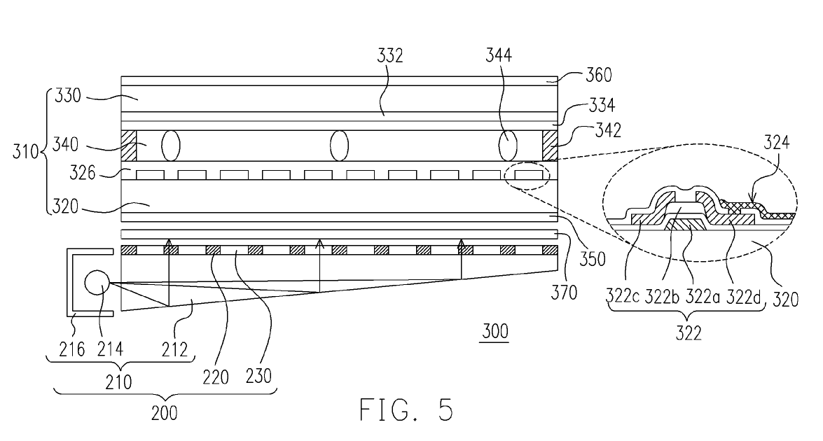

FIG. 5 is a schematic cross-sectional view of a liquid crystal display according to one preferred embodiment of the present invention. Since the aforementioned back light module 200 is capable of producing a full-color surface light source, the back light module 200 finds applications within a transmissive or transflective type of liquid crystal display 300.

The liquid crystal display 300 in FIG. 5 comprises a back light module 200 and a liquid crystal display panel 310. The liquid crystal display panel 310 is positioned over the back light module 200. The liquid crystal display panel 310 furthermore comprises an array substrate 320, an opposite substrate 330 and a liquid crystal layer 340. The opposite substrate 330 is positioned over the array substrate 320 and the liquid crystal layer 340 is sandwiched between the array substrate 320 and the opposite substrate 330.

The array substrate 320 is a thin film transistor array substrate having a plurality of thin film transistors (TFT) 322 thereon and each thin film transistor 322 corresponds with a pixel electrode 324. Each thin film transistor 322 furthermore comprises a gate 322a, a channel layer 322b, a source 322c and a drain 322d. The gate 322a is connected to a scan line for turning on or turning off the channel layer 322b. The source 322c is connected to a data line. When the gate 322a is coupled to a suitable voltage source, the channel layer 322b is switched to a conductive state. In the conductive state, any data related to the display of an image will be written into the pixel electrode 324 through the data line, the source 322c, the channel layer 322b and the drain 322d. In short, the thin film transistor 322 serves as a switch for controlling the state of each pixel electrode 324 so that the desired image is displayed.

The opposite substrate 330 is a glass substrate or any substrate fabricated using a transparent material. The interior surface of the opposite substrate 300 has a common electrode layer 332 thereon. Using the thin film transistors 322 as driving devices, liquid crystal molecules between the common electrode layer 332 and the pixel electrode 324 are twisted accordingly.

Furthermore, the interior surface of the thin film transistor array substrate 320 has an alignment film 326 that covers the thin film transistors 322 and the pixel electrodes 324. The interior surface of the opposite substrate 330 also has an alignment film 334 that covers the common electrode layer 332. These two alignment layers 326, 334 orients the molecules within the liquid crystal layer 340. In addition, a plastic sealant 342 bounds the array substrate 320 and the opposite substrate 330 together. The cavity bounded by the array substrate 320, the opposite substrate 330 and the plastic sealant 342 holds the liquid crystal layer 340. In addition, a few spacers 344 may be introduced inside the cavity to maintain a constant cell gap between the array substrate 320 and the opposite substrate 330. Moreover, polarizing plates 350, 360 may be attached to the exterior surface of the array substrate 320 and the opposite substrate 330 respectively to display images. Furthermore, an optical film plate 370 such as a prism plate may also be inserted in the space between the liquid crystal display panel 310 and the back light module 200.

Both of the back light module in FIG. 2 and the back light module in FIG. 4 according to the present invention can be used to provide a full-color light source for a liquid crystal display. In addition, the back light modules can also be applied to an active matrix LCD as well as a passive matrix LCD. In other words, the electrode layer of the liquid crystal display panel is not limited to the combination of common electrodes with pixel electrodes. The liquid crystal display panel of the present invention may be constructed using a top substrate, a bottom substrate and a liquid crystal layer between the two. The bottom substrate has a plurality of first stripe electrodes and the top substrate has a plurality of second stripe electrodes. The first stripe electrodes extend in a direction perpendicular to the second stripe electrodes. Furthermore, an alignment film is formed over the surface of these stripe electrodes.

For example, the advantages of the back light module and the liquid crystal display using the back light module of the present invention include: 1. The back light module provides a full-color surface light source to a liquid crystal display directly. 2. The liquid crystal display uses a transparent substrate, an array substrate together with a back light module that provides a full-color surface light source. Since there is no need to fabricate film layers including the color-filtering film and the over-coating, the fabrication process is simplified and the production cost is reduced.

It will be apparent to those skilled in the art that various modifications and variations can be made to the structure of the present invention without departing from the scope or spirit of the invention. In view of the foregoing, it is intended that the present invention cover modifications and variations of the present invention provided they fall within the scope of the following claims and their equivalents.

1. A back light module for providing a full-color surface light source, comprising:
a surface light source;
a light-shielding matrix formed on the surface of the surface light source, wherein the light-shielding matrix has a plurality of lattice points that exposes the underlying surface light source; and
a fluorescent layer formed inside the lattice points.

2. The back light module of claim 1, wherein the surface light source comprises a cold cathode fluorescent flat lamp.

3. The back light module of claim 1, wherein the surface light source furthermore comprises:
a light-guiding plate having a light-receiving surface, a light-emitting surface and a light-diffusing surface;
a reflective holder positioned close to the light-receiving surface; and
a linear light source enclosed by the reflective holder.

4. The back light module of claim 2, wherein the light-diffusing surface has a plurality of V-cuts.

5. The back light module of claim 2, wherein the linear light source is selected from a group consisting of a cold cathode fluorescent lamp and a light-emitting diode array.

6. The back light module of claim 1, wherein the fluorescent layer comprises:
a plurality of first fluorescent-based material for converting the light from the surface light source into a first color;
a plurality of second fluorescent-based material for converting the light from the surface light source into a second color; and
a plurality of third fluorescent-based material for converting the light from the surface light source into a third color.

7. The back light module of claim 6, wherein the first fluorescent-based material, the second fluorescent-based material and the third fluorescent-based material are arranged to form a mosaic pattern, a triangular pattern, a stripe pattern or a four-pixel pattern.

8. The back light module of claim 1, wherein the surface light source provides a light source with a first color and the fluorescent layer is formed in some of the lattice points only, the fluorescent layer comprises:
a plurality of first fluorescent-based material for converting the first color light from the surface light source into a second color; and
a plurality of second fluorescent-based material for converting the first color light from the surface light source into a third color.

9. The back light module of claim 8, wherein the first fluorescent-based material, the second fluorescent-based material and the lattice point without any fluorescent material are arranged to form a mosaic pattern, a triangular pattern, a stripe pattern or a four-pixel pattern.

10. A liquid crystal display, comprising:
a back light module, comprising:
a surface light source;
a light-shielding matrix formed on the surface of the surface light source, wherein the light-shielding matrix has a plurality of lattice points that exposes the underlying surface of the surface light source;
a fluorescent layer formed inside the lattice points; and
a liquid crystal display panel positioned over the back light module.

11. The liquid crystal display of claim 10, wherein the surface light source comprises a cold cathode fluorescent flat lamp.

12. The liquid crystal display of claim 10, wherein the surface light source furthermore comprises:
a light-guiding plate having a light-receiving surface, a light-emitting surface and a light-diffusing surface;
a reflective holder positioned next to the light-receiving surface; and
a linear light source enclosed within the reflective holder.

13. The liquid crystal display of claim 12, wherein the light-diffusing surface has a plurality of V-cuts thereon.

14. The liquid crystal display of claim 12, wherein the linear light source is selected from a group consisting of a cold cathode fluorescent lamp and a light-emitting diode array.

15. The liquid crystal display of claim 10, wherein the fluorescent layer comprises:
a plurality of first fluorescent-based material for converting light from the surface light source into a first color;
a plurality of second fluorescent-based material for converting light from the surface light source into a second color; and
a plurality of third fluorescent-based material for converting light from the surface light source into a third color.

16. The liquid crystal display of claim 15, wherein the first fluorescent-based material, the second fluorescent-based material and the third fluorescent-based material are arranged to form a mosaic pattern, a triangular pattern, a stripe pattern or a four-pixel pattern.

17. The liquid crystal display of claim 10, wherein the surface light source provides a light source with a first color and the fluorescent layer is formed in some of the lattice points only, the fluorescent layer comprises:
a plurality of first fluorescent-based material for converting the first color light from the surface light source into a second color; and
a plurality of second fluorescent-based material for converting the first color light from the surface light source into a third color.

18. The liquid crystal display of claim 17, wherein the first fluorescent-based material, the second fluorescent-based material and the lattice point without any fluorescent material are arranged to form a mosaic pattern, a triangular pattern, a stripe pattern or a four-pixel pattern.

19. The liquid crystal display of claim 10, wherein the liquid crystal display panel furthermore comprises:
an array substrate;
an opposite substrate formed over the array substrate; and
a liquid crystal layer sandwiched between the array substrate and the opposite substrate.

20. The liquid crystal display of claim 19, wherein the array substrate comprises a thin film transistor array substrate with an interior surface having an array of thin film transistors thereon and a plurality of pixel electrodes that correspond with the thin film transistors.

21. The liquid crystal display of claim 20, wherein the display furthermore comprises a first alignment film positioned over the interior surface of the thin film transistor array substrate to cover the thin film transistors and the pixel electrodes.

22. The liquid crystal display of claim 20, wherein the opposite substrate furthermore comprises a common electrode layer.

23. The liquid crystal display of claim 22, wherein the display furthermore comprises a second alignment film positioned over the interior surface of the opposite substrate to cover the common electrode layer.

24. The liquid crystal display of claim 10, wherein the liquid crystal display panel furthermore comprises:
a bottom substrate;
a top substrate positioned over the bottom substrate; and
a liquid crystal layer sandwiched between the top substrate and the bottom substrate.

25. The liquid crystal display of claim 24, wherein the bottom substrate has a plurality of first stripe electrodes and the top substrate has a plurality of second stripe electrodes such that the first stripe electrodes extend in a direction perpendicular to the second stripe electrodes.

26. The liquid crystal display of claim 25, wherein the display furthermore comprises a first alignment film positioned over the interior surface of the bottom substrate to cover the first stripe electrodes.

27. The liquid crystal display of claim 25, wherein the display furthermore comprises a second alignment film positioned over the interior surface of the top substrate to cover the second stripe electrodes.

28. The liquid crystal display of claim 10, wherein the display furthermore comprises a first polarizing plate and a second polarizing plate such that the first polarizing plate and the second polarizing plate are attached to the surface of the liquid crystal display panel.

29. The liquid crystal display of claim 10, wherein the display furthermore comprises a prism positioned between the liquid crystal display panel and the back light module.
